(19) United States
(12) Patent Application Publication
(10) Pub. No.: US 2026/0217895 A1
(43) Pub. Date: Jul. 30, 2026

(54) POLYURETHANE COMPOSITION FOR ROTATIONAL MOLDING AND USE THEREOF

(71) Applicant: BASF SE, Ludwigshafen am Rhein (DE)

(72) Inventors: Hai Lin WANG, Shanghai (CN); Meng Dan WANG, Shanghai (CN); Feng Chao HU, Shanghai (CN); Wei DA, Shanghai (CN)

(73) Assignee: BASF SE, Ludwigshafen am Rhein (DE)

(21) Appl. No.: 19/145,310

(22) PCT Filed: Jan. 2, 2024
(86) PCT No.: PCT/EP2024/050002

§ 371 Date: Jul. 2, 2025

(30) Foreign Application Priority Data
Jan. 6, 2023 (WO) PCT/CN2023/070995

(51) Int. Cl. C08G 18/40; B29C 41/04; C08G 18/20; C08G 18/32; C08G 18/48

(52) U.S. Cl. CPC C08G 18/4072; B29C 41/04; C08G 18/2027; C08G 18/324; C08G 18/4816; C08G 18/482; C08G 18/4891

(57) ABSTRACT

Disclosed is a two-component polyurethane system for rotational molding, which includes a polyol component including a high functionality polyol with a functionality of larger than 3.5, a bio-sourced polyol, a viscosity modifier, a chain extender in a content of from 10 wt. % to 20 wt. %, based on a total weight of the polyol component, an amine catalyst, and a rheological modifier; and a di- or polyisocyanate component. Also provided are an article produced from the two-component polyurethane system and a method of producing the same.

### TECHNICAL FIELD

The present disclosure relates to a polyurethane composition for rotational molding, especially a polyurethane composition for rational molding of hollow bodies such as clothes mannequins, and use of the polyurethane composition.

### BACKGROUND

Hollow bodies, such as clothes mannequins, human body models for entertainments or education, are widely used. Currently, mannequins are mostly made by fiber-reinforced plastic in manual production. The manual production process is low efficient. Due to volatility of the molding materials, agents, and auxiliaries, workers often face unpleasant and unsafe atmosphere or environment. Rotational molding process, in which polymer composition are used, has much higher efficiency and is friendly to operators.

However, the conventional PU compositions contain hazard chemicals, such as heavy metal catalysts, plasticizer etc. Also, in rotational molding process, it is hard to achieve thin coating with even thickness.

WO2021/114664A1 disclosed a polyurethane elastomer for manufacturing quick-demolding high temperature-resistant transparent model material.

CN102040824B disclosed a cast polyurethane elastomer composition for mannequins, which is a two-component system.

### SUMMARY

An objective of the present disclosure is to overcome the problems of the prior art discussed above and to provide a polyurethane composition, which, when processed into a hollow body, can achieve a thin layer of coating with even and reduced thickness. The composition contains bio-sourced raw materials and essentially no metal-based catalysts.

Surprisingly, it has been found by the inventors that the above object can be achieved by a two-component polyurethane system for rotational molding comprising:
a polyol component comprising
a high functionality polyol with a functionality of larger than 3.5,
a bio-sourced polyol,
a viscosity modifier,
a chain extender in a content of from 10 wt. % to 20 wt. %, based on a total weight of the polyol component,
an amine catalyst,
a rheological modifier; and
a di- or polyisocyanate component.

In a further aspect, the present disclosure provides an article produced from the polyurethane system.

In another further aspect, the present disclosure provides a method of producing an article from the two-component polyurethane system, including:
providing a two-component polyurethane system;
placing the two-component polyurethane system within a hollow mold;
subjecting the hollow mold to a rotational movement and causing the two-component polyurethane system to cure and form an article; and
retrieving the article.

It has been surprisingly found in this application that, the two-component polyurethane system can achieve a fast curing and be made into hollow articles with even thickness of shells through rotational molding.

### DETAILED DESCRIPTION

Unless defined otherwise, all technical and scientific terms used herein have the meaning commonly understood by a person skilled in the art to which the present disclosure belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Unless otherwise identified, “polyether segment” refers to any bi-valent segment consisting of one or more repeating units of alkylene oxide. The alkylene oxide may include without limitation to tetrametylene oxide, ethylene oxide, propylene oxide, butylene oxide, pentylene oxide, hexylene oxide, or styrene oxide. Polyether segments include without limitation to, e.g., —[CH₂CH₂CH₂CH₂O]ₐ—, —[CH₂CH₂O]_{b}—, —[CH₂CH(CH₃)O]_{c}—, —[CH₂CH₂O]_{d}[CH₂CH(CH₃)O]ₑ—, and/or any other combination of alkylene oxides, wherein a through e are independently an integer not less than 1.
Tetrametylene oxide is —CH₂CH₂CH₂CH₂O—.
Ethylene oxide (EO) is —CH₂CH₂O—.
Propylene oxide (PO) is —CH(CH₃)CH₂O—, or —CH₂CH(CH₃)O—.
Butylene oxide (BO) is —CH(C₂H₅)CH₂O—, —C(CH₃)₂CH₂O—, —CH₂C(CH₃)₂O—, —CH(CH₃)CH(CH₃)O—, or —CH₂CH(C₂H₅)O—.
Pentylene oxide is —CH(C₃H₇)CH₂O—, —CH₂CH(C₃H₇)O—, —CH(C₂H₅)CH(CH₃)O—, —CH(CH₃)CH(C₂H₅)O—, —C(CH₃)(C₂H₅)CH₂O—, —CH₂C(CH₃)(C₂H₅)O—, —C(CH₃)₂CH(CH₃)O—, or —CH₂(CH₃)C(CH₃)₂O—.
Hexylene oxide is —CH(C₄H₉)CH₂O—, —CH₂CH(C₄H₉)O—, —C(C₃H₇)(CH₃)CH₂O—, —CH₂C(C₃H₇)(CH₃)O—, —CH(C₃H₇)CH(CH₃)O, —CH(CH₃)CH(C₃H₇)O—, —C(C₂H₅)(C₂H₅)CH₂O—, —CH₂C(C₂H₅)₂O—, —CH(C₂H₅)CH(C₂H₅)O—, —C(CH₃)₂CH(C₂H₅)O—, —CH(C₂H₅)C(CH₃)₂O—, or —CH(CH₃)₂C(CH₃)₂O—.
Styrene oxide is —CH(C₆H₅)CH₂O— or —CH₂CH(C₆H₅)O—.

Functionality or Fn of a polyol (including polyester polyols, polyether polyols, or other kinds of polyols) is defined as the number of hydroxy groups per molecule.

Mₙ is defined as the number average of the molecular weight.

Isocyanate index or NCO index is defined as the ratio of number of NCO groups over number of isocyanate-reactive hydrogen atoms present in a formulation, given as a percentage:

Isocyanate index=[NCO]×100(%)/[active hydrogen]

In other words, the isocyanate index expresses the percentage of isocyanate actually used in a formulation with respect to the amount of isocyanate theoretically required for reacting with the amount of isocyanate-reactive hydrogen used in a formulation.

Polyurethanes are segmented polymers having soft segments and hard segments. Soft segments are derived from the hydroxyl terminated polyether, polyester, or polycarbonate. Hard segments are derived from isocyanate and chain extender. The chain extender is typically one or more small-molecular diols, such as 1,3-propane glycol or 1,4-butane glycol.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

### Polyurethane System

According to the present disclosure, the polyurethane system includes a polyol component including a high functionality polyol with a functionality of larger than 3.5, a bio-sourced polyol, a viscosity modifier, a chain extender in a content of from 10 wt. % to 20 wt. %, based on a total weight of the polyol component, an amine catalyst, and a rheological modifier; and an isocyanate component.

The polyol component and the isocyanate component may be stored separately before mixing and production of articles, as commonly known in the art. The polyurethane system may be mixed and casted, molded, sprayed, or shaped by any other method known by skilled person to form an article.

Preferably, an isocyanate index of the two-component polyurethane system is within a range of from 80 to 120, preferably a range of from 90 to 110.

### Polyol Component

### High Functionality Polyol

The polyol component comprises a high functionality polyol with a functionality of larger than 3.5. The high functionality polyol may be a polyether polyol, a polyester polyol, a polycarbonate polyol, a polybutadiene polyol, or any combination thereof. In case of polyether polyol, the high functionality polyol may be initiated by a starter and alkylene oxide. The starter may be a multi-hydroxyl compound or an amine. The starter may include glycerol, trimethylol propane, pentaerythritol, sorbitol, sucrose, ammonia, triethanolamine, p-phenylenediamine, ethylenediamine, propylenediamine, butylenediamine, and diethylene triamine.

Due to large number of hydroxyl groups per molecule, the high functionality polyol has a high reactivity and results in a highly crosslinked network, which contributes to a high mechanical strength of the polyurethane articles, especially the hollow bodies.

Preferably, the high functionality polyol is a polyether polyol initiated by an amine. The amine preferably has at least three active hydrogen atoms bonded with a nitrogen atom. Exemplary amines include without limitation to p-phenylenediamine, ethylenediamine, propylenediamine, butylenediamine, diethylene triamine. The polyether moiety may be an oxyethylene moiety, an oxypropylene moiety, an oxytetramethylene moiety, or any combination thereof.

The high functionality polyol preferably has a content of from 10 wt. % to 40 wt. %, more preferably a content of from 15 wt. % to 30 wt. %, based on the total weight of the polyol component.

Exemplary high functionality polyols can be commercially available from various vendors, e.g., LUPRANOL® VP 9393, LUPRANOL® VP 9340, LUPRANOL® VP 9342, LUPRANOL® VP 9345, Quadrol® L from BASF; Puranol RF TD 400, Puranol RF TD 480, Puranol RF ED 403, Puranol ED 408 from Jiahua; VORAMOL™ 391, VORAMOL™ 800, VORAMOL™ RA500, VORAMOL™ RA640 from Dow.

### Bio-Sourced Polyols

Examples of bio-sourced polyol include castor oil, hydrogenated castor oil, soybean oil polyols, palm oil polyols, rosin-based polyols, hydroxyl-modified fatty acid esters based on myristoleic acid, palmitoleic acid, oleic acid, vaccenic acid, petroselic acid, gadoleic acid, erucic acid, nervonic acid, linoleic acid, linolenic acid, stearidonic acid, arachidonic acid, timnodonic acid, clupanodonic acid and cervonic acid, and derivatives thereof. By the term “derivatives”, these include alkoxylates, transesterification products, products of ozonolysis/reduction, products of ozonolysis/glycolysis, products of hydroformylation/reduction, products of epoxidation/ring-opening to the carbon-carbon double bonds, or other hydroxyl-containing products of those oils and esters. Preference here is given to using soybean oil polyols, castor oil and their reaction products with alkylene oxides or ketone-formaldehyde resins. Such compounds are for example available from BASF under the designation Sovermol® 750, Sovermol® 805. As known in the art, castor oil contains as its main constituent triglycerides of ricinoleic acid, which have hydroxyl groups in the carbon chain. Polyether polyol based on castor oil is obtained by using castor oil as starting material with ethylene oxide and/or propylene oxide. Soybean oil can be converted to polyols by means of epoxidation, ring-open reaction, ozone-oxidation, transesterification, etc.

Preferably, the bio-sourced polyol has a functionality of 2.0 to 3.5, preferably 2.5 to 3.0. The relatively high functionality will result in a crosslinked network and rigid and resilient articles made from the two-component polyurethane system.

Preferably, the bio-sourced polyol has a content of from 20 to 50 wt. %, preferably a content of from 25 to 45 wt. %, more preferably a content of from 25 to 40 wt. %, based on the total weight of the polyol component.

### Other Polyester Polyols, Polycarbonate Polyol, and Polyether Polyols

In further embodiments, the polyol component provided in the present disclosure can comprise other polyols. The other polyols include small molecule polyols, polyether polyols, polyester polyols, or polycarbonate polyols.

Small molecule polyols include without limitation to glycol, diethylene glycol, dipropylene glycol, glycerol, pentaerythritol, sucrose, etc.

Polyester polyols, polycarbonate polyols, and polyether polyols are collectively known as polyols. Polyol refers to a polyhydroxy compound. Preferably, polyhydroxy compounds having a functionality of 2 to 8, more preferably 3 to 6, and a hydroxyl number of 150 to 850 mg KOH/g, more preferably 200 to 600 mg KOH/g are examples of higher molecular weight compounds having at least two reactive hydrogen atoms.

For example, polythioether polyols, polyester amides, polyacetals containing hydroxyl groups, aliphatic polycarbonates containing hydroxyl groups, and preferably, polyester polyols and polyether polyols. In addition, mixtures of at least two of the aforesaid polyhydroxy compounds can be used as long as these have an average hydroxyl number in the aforesaid range.

Suitable polyester polyols can be produced, for example, from organic dicarboxylic acids with 2 to 12 carbons, preferably aliphatic dicarboxylic acids with 4 to 6 carbons, and multivalent alcohols, preferably diols, with 2 to 12 carbons, preferably 2 to 6 carbons. Examples of dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids can be used individually or in mixtures. Instead of the free dicarboxylic acids, the corresponding dicarboxylic acid derivatives may also be used such as dicarboxylic acid mono- or di-esters of alcohols with 1 to 4 carbons, or dicarboxylic acid anhydrides. Dicarboxylic acid mixtures of succinic acid, glutaric acid and adipic acid in quantity ratios of 20-35:35-50:20-32 parts by weight are preferred, especially adipic acid. Examples of divalent and multivalent alcohols, especially diols, include ethanediol, diethylene glycol, 1,2- and 1,3-propanediol, dipropylene glycol, 1,4-butanediol, 1,5-pentanediol, 1,6-hexanediol, 1,10-decanediol, glycerin, and trimethylolpropane. Glycol, diethylene glycol, 1,4-butanediol, 1,5-pentanediol, 1,6-hexanediol, or mixtures of at least two of these diols are preferred, especially mixtures of 1,4-butanediol, 1,5-pentanediol, and 1,6-hexanediol.

The polyester polyols can be produced by polycondensation of organic polycarboxylic acids, e.g., aromatic or preferably aliphatic polycarboxylic acids and/or derivatives thereof and multivalent alcohols in the absence of catalysts or preferably in the presence of esterification catalysts, preferably in an atmosphere of inert gases, e.g., nitrogen, carbon dioxide, helium, argon, etc., in the melt at temperatures of 150° C. to 250° C., preferably 180° C. to 220° C., optionally under reduced pressure, up to the desired polymerization degree, which is preferably less than 10, especially less than 5. In a preferred embodiment, the esterification mixture is subjected to polycondensation at the temperatures mentioned above up to an acid value of 80 to 30, preferably 40 to 30, under normal pressure and then under a pressure of less than 500 mbar, preferably 50 to 150 mbar. Examples of suitable esterification catalysts include iron, cadmium, cobalt, lead, zinc, antimony, magnesium, titanium, and tin catalysts in the form of metals, metal oxides or metal salts. However, the polycondensation may also be per formed in liquid phase in the presence of diluents and/or entraining agents such as benzene, toluene, xylene, or chlorobenzene for azeotropic distillation of the water of condensation.

To produce the polyester polyols, the organic poly carboxylic acids and/or derivatives thereof and multi valent alcohols are preferably polycondensed in a mole ratio of 1:1-1.8, preferably 1:1.05-1.2.

The resulting polyester polyols preferably have a functionality of 2 to 3, and a hydroxyl number of 150 to 500, and especially 200 to 400.

Polyether polyols, which can be obtained by known methods, may also be used as the polyhydroxy compounds. For example, polyether polyols can be produced by anionic polymerization with alkali hydroxides such as sodium hydroxide or potassium hydroxide or alkali alcoholates, such as sodium methylate, sodium ethylate or potassium ethylate or potassium isopropylate as catalysts and with the addition of at least one initiator molecule containing 2 to 8, preferably 3 to 8, reactive hydrogens or by cationic polymerization with Lewis acids such as antimony pentachloride, boron trifluoride etherate, etc., or bleaching earth as catalysts from one or more alkylene oxides with 2 to 4 carbons in the alkylene radical.

Suitable cyclic ethers and alkylene oxides include, for example, tetrahydrofuran, 1,3-propylene oxide, 1,2- and 2,3-butylene oxide, styrene oxide, and preferably ethylene oxide and 1,2-propylene oxide. The alkylene cyclic ethers and oxides may be used individually, in alternation, one after the other or as a mixture. Examples of suitable initiators include water, multivalent alcohols, organic dicarboxylic acids such as succinic acid, adipic acid, phthalic acid and terephthalic acid, aliphatic and aromatic, optionally N-mono-, N,N-, and N,N′-dialkyl substituted diamines with 1 to 4 carbons in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamines, 2,3-, 2,4- and 2,6-toluenediamine and 4,4′-, 2,4′-, and 2,2′-diaminodiphenylmethane.

Multivalent alcohols, especially divalent, trivalent, and/or tetravalent alcohols are preferred such as ethanediol, 1,2-propanediol and 1,3-propanediol, diethylene glycol, dipropylene glycol, 1,4-butanediol, 1,6-hexanediol, glycerin, trimethylolpropane, erythritol, pentaerythritol, sorbitol, and sucrose.

Suitable initiators also include alkanolamines such as ethanolamine, diethanolamine, N-methyl- and N-ethyl ethanolamine, N-methyl- and N-ethyl diethanolamine and triethanolamine plus ammonia.

The polyether polyols have a functionality of preferably 3 to 8 and especially 3 to 6 and have a hydroxyl number of 300 to 850, preferably 350 to 800.

Also suitable as polyether polyols are melamine polyether polyol dispersions according to U.S. Pat. No. 4,293,657; polymer polyether polyol dispersions prepared from polyepoxides and epoxide resin hardeners in the presence of polyether polyols according to U.S. Pat. No. 4,305,861; dispersions of aromatic polyesters in polyhydroxy compounds according to U.S. Pat. No. 4,435,537; dispersion of organic and/or inorganic fillers in polyhydroxy compounds according to U.S. Pat. No. 4,243,755; polyurea polyether polyol dispersions according to DE A 31 2 402, tris-(hydroxyalkyl) isocyanurate polyether polyol dispersions according to U.S. Pat. No. 4,514,526 and crystallite suspensions according to U.S. Pat. No. 4,560,708, whereby the details in the aforesaid patents are to be regarded as part of the patent disclosure, and are herein incorporated by reference.

Like the polyester polyols, the polyether polyols may be used either individually or in the form of mixtures. Furthermore, they can be mixed with the aforesaid dispersions, suspensions, or polyester polyols as well as polycarbonate polyols.

Suitable hydroxyl group-containing polycarbonates include those of the known type such as those obtained by reaction of diols, e.g., 1,3-propanediol, 1,4-butanediol, and/or 1,6-hexanediol, diethylene glycol, triethylene glycol or tetraethylene glycol and diaryl carbonates, e.g., diphenyl carbonate, or phosgene.

The polyester amides include the mainly linear condensates obtained from multivalent saturated and/or unsaturated carboxylic acids and their anhydrides and amino alcohols, or mixtures of multivalent alcohols and amino alcohols and/or polyamines.

### Chain Extenders

The polyol component comprises chain extenders. Chain extenders, as part of the hard segment, are crucial to the rotational molding of the polyurethane system. Without bound by any theory, the formation of hard segment may bring resilience and strength to the polyurethane, which are required for a successful rotational molding of articles, especially hollow article. Usually, a hollow article is sensitive to exerted forces, vibration, or impact as its shell may be thin and breakable.

Preferably, the chain extender is in a content of from 10 wt. % to 20 wt. %, based on a total weight of the polyol component.

Suitable chain extenders include preferably diols. Typical examples are aliphatic, cycloaliphatic and/or araliphatic diols having 2 to 14, more preferably 4 to 10 carbon atoms such as ethylene glycol, 1,3-propanediol, 1,10-decanediol, o-, m-, p-dihydroxycyclohexane, diethylene glycol, dipropylene glycol, and preferably 1,4-butanediol, 1,6-hexanediol, and bis(2-hydroxyethyl) hydroquinone.

### Curing Agents

In some preferred embodiments, the polyol component comprises a curing agent. The curing agent may include an organic amine with at least two amino groups. The curing agent may expedite the reaction between hydroxyl groups and isocyanate groups and facilitate crosslinking. In such process, the polymer toughens and hardens. The curing agent is preferably in a content of from 0.1 wt. % to 2.5 wt. %, based on the total weight of the polyol component. The addition of curing agents into the system is beneficial in that the expedited reaction will make the mixture viscous and reduce the demolding time.

Exemplary curing agent may be one or more alkanolamines, aromatic diamines, aliphatic diamines, or cycloaliphatic diamines. Specific examples include without limitation to ethanolamine and/or isopropanolamine; dialkanolamines, such as diethanolamine, N-methyl-, N-ethyldiethanolamine, diisopropanolamine; trialkanolamines such as triethanolamine, triisopropanolamine; and the addition products from ethylene oxide or 1,2-propylene oxide, and alkylenediamines having 2 to 6 carbon atoms in the alkylene radical such as N,N′-tetra(2-hydroxyethyl)-ethylenediamine and N,N′-tetra(2-hydroxypropyl)ethylenediamine; dimethyl toluene diamine; diethyl toluene diamine; 1,3,5-triethyl-2,6-diaminobenzene; 4,4′-methylene diorthochloroaniline; metaxylene diamine (MXDA); isophorone diamine (IPDA); 1,3-bis(aminomethyl)cyclohexane; 1,2-, 1,3-, or 1,4-cyclohexanediamine; 1,2-, 1,3-, or 1,4-bis(aminomethyl)cyclohexane.

### Viscosity Modifiers

According to the present disclosure, a viscosity modifier is present in the polyol component. The viscosity modifier can be a mixture of a polyhydroxyl compound or polymer and a filler. The viscosity modifier tunes the viscosity of the polyol component and the reacting mixture of the polyol component and the di- or polyisocyanate component. The viscosity modifier has a viscosity at 25° C. of more than 2,000 mPa s; preferably a viscosity at 25° C. of more than 3,500 mPa s; more preferably, a viscosity at 25° C. of more than 5,000 mPa s, as measured in accordance with DIN EN 3219. Preferably, the content of the filler in the viscosirt modifier is from 20 wt. % to 80 wt. %, based on a total weight of the viscosity modifier.

Exemplary viscosity modifier includes GPOP H45, GPOP-36/30 from Sinopec Shanghai Gaoqiao Petrochemical Company or CHP-H30, CHP-H45, CHP-H50 from Changhua.

### Catalysts

To achieve a fast curing, a catalyst is need in the polyol component of the polyurethane system. The catalyst used in the present disclosure may include one or more amine-based catalysts. The catalysts can greatly accelerate the reaction of the hydroxyl group containing compounds of components and optionally with the polyisocyanates.

Examples of the amine-based catalysts may include amines such as 2,3-dimethyl-3,4,5,6-tetrahydropyrimidine, tertiary amines such as triethylamine, tributylamine, triethylene diamine, 1-methylimidazole, dimethylbenzylamine, N-methylmorpholine, N-ethylmorpholine, N-cyclohexylmorpholine, dimethylpiperazine, 1,2-dimethylimidazole, 1-azabicyclo[3.3.0]octane and preferably 1,4-diaza-bicyclo[2.2.-2]octane and alkanolamine compounds such as triethanolamine, triisopropanolamine, N-methyl- and N-ethyldiethanolamine and dimethylethanolamine.

The metal-based catalyst may include a potassium compound selected from a group consisting of potassium hydroxide, potassium carbonate, potassium bicarbonate, potassium benzoate, potassium formate, potassium acetate, potassium propionate, potassium butyrate, potassium valerate, potassium caproate, potassium caprylate, potassium 2-ethylhexanoate, potassium neodecanoate, potassium caprate, potassium salicylate, potassium laurate, potassium oleate, potassium maleate, potassium citrate, potassium oxalate, potassium methoxide, potassium cellulose, potassium carboxymethylcellulose, potassium hyaluronate, potassium alginate, potassium gluconate and any combination thereof. Preferably the metal-based catalyst does not contain tin, mercury, copper, nickel, zinc. Such metal elements are generally considered as environmental hazardous.

Suitable catalysts include tris-(dialkylamino-s-hexahydrotriazines, especially tris(N,N-dimethylaminopropyl)-s-hexahydrotriazine, tetraalkylammonium hydroxides such as tetramethylammonium hydroxide, alkali hydroxides such as sodium hydroxide and alkali alcoholates such as sodium methylate and potassium isopropylate as well as alkali salts of long chain fatty acids with 10 to 20 carbon atoms and optionally OH dependent groups.

### Rheological Modifiers

To improve the rheological performance of the polyurethane system, one or more rheological modifier is added to the polyol component. Exemplary rheological modifier includes without limitation to, BYK® 410, 431, Efka® RM 1900, RM 1920, RM 1965 from BASF, Borchi® Gel Thixo 2 from Bochers.

The rheological modifiers may make the polyurethane system viscous and flowable after being shaken, stressed, or agitated. The thixotropy of the polyurethane system will result in an evenly thin hollow body, avoiding defects or holes in the surface. It is generally understood that the centrifugal force generated during rotational molding is the driving force to spread the polymer/reacting mixture on the inner surface of the mold. The rheological modifier will change the rheological behavior of the polymer/reacting mixture and make it flowable while viscous. Thus, an evenly thick layer of the molded article can be realized without forming overly thick or thin layers, especially at corners or joints, which abound in anatomical models of human body, torso, or head, or mannequins for fashion industry.

### Other Additives and Auxiliaries

Optionally other additives and/or auxiliaries may be incorporated into the polyol component to produce the rotationally molded article. Examples include moisture scavenger, flame retardants, UV absorbers, surfactants, inorganic fillers, organic fillers, dyes, pigments, odor scavengers, hydrolysis preventing agents, fungistatic agents, bacteriostatic agents, matting agents, antistatic agents.

Preferably, moisture scavenger is present in the formulation. The moisture scavenger is able to absorb water and prevent it from reacting with isocyanate, which will release carbon dioxide to blow the polyurethane system and deteriorate the mechanical strength of final products.

### Isocyanate Component

The isocyanate component in the present disclosure comprises one or more selected from the group consisting of aliphatic, cycloaliphatic, araliphatic, and aromatic isocyanates. For example, the isocyanate component may include alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-, 2,2′-, and 2,4′-dicyclohexylmethane diisocyanate as well as the corresponding isomeric mixtures and preferably aromatic diisocyanates and polyisocyanates such as 2,4- and 2,6-toluene diisocyanate (TDI) and the corresponding isomeric mixtures 4,4′-, 2,4′-, and 2,2′-diphenylmethane diisocyanate (MDI) and the corresponding isomeric mixtures, mixtures of 4,4′- and 2,4′-diphenylmethane diisocyanates and polyphenylenepolymethylene polyisocyanates (polymeric MDI), as well as mixtures of polymeric MDI and toluene diisocyanates. The organic di and polyisocyanates can be used individually or in the form of mixtures.

### Molding Process

The present disclosure also provides a process for preparing an article from the two-component polyurethane system. The process includes several steps:
providing a two-component polyurethane system according to any of claims 1 through 9;
placing the two-component polyurethane system within a hollow mold;
subjecting the hollow mold to a rotational movement and causing the two-component polyurethane system to cure and form an article; and
retrieving the article.

In the process, a two-component polyurethane system as described above is provided.

Then, the two-component polyurethane system is placed within a hollow mold. Conventional or specially designed hollow molds known to the skilled persons may be used.

The hollow mold, with its content of the two-component polyurethane system is subjected to a rotational movement. The rotational movement may be around one or more axes. The rotational movement may generate a centrifugal force inside the hollow mold, which then drives the polyurethane system to diffuse and coat the inner surface of the hollow mold. Meanwhile, the components react and jellify. The hollow mold may be heated, either by external source or by the exothermal effect of the reaction between the components. During the rotational movement, the heating may cause the two-component polyurethane system to cure and form an article. Preferably, the rotational movement may have a duration of 3 to 30 minutes, more preferably a duration of 5 to 10 minutes. The rotational movement preferably has a rotational speed of 10 to 60 round per minute (RPM).

After the curing completes, the hollow mold may be opened, and the article may be retrieved.

### Applications

The present disclosure further provides an article produced from the two-component polyurethane system described above. The article is preferably a hollow body, more preferably a mannequin. The article may find applications in fashion industry as mannequins; in automobile industry as shells, components, or parts; in educational, art, or museum institutions as display models.

### EXAMPLES

### Measuring and Test Methods

The measuring and test methods are shown in Table 1.

TABLE 1
Measuring and test standards

| Property | Unit | Testing standard |
|---|---|---|
| Gel time | s | Annex E of EN 14315-1 |
| Shore hardness | D | ASTM D2240 |

### Materials

The materials used in the examples are as follows:
LUPRANOL® VP-9345, a polyether polyol with a functionality of 4, OH number: ca. 405 mgKOH/g, molecular weight, ca. 550 g/mol; viscosity, ca. 12,800 mPa·s (25° C.), from BASF;
LUPRANOL® 2095, a trifunctional polyether polyol which contains primary hydroxyl groups, OH value of 35 mgKOH/g; viscosity, ca. 850 mPa·s (25° C.), from BASF;
Castor oil, commercially available from BASF, with OH number of 163 mg KOH/g, and a functionality of about 2.7. Castor oil is a mixture of triglycerides characterized by about 90 wt % of triglyceride of ricinoleic acid; viscosity, ca. 1,025 mPa·s (20° C.);
Sovermol® 805, branched polyether-ester polyol based on soybean oil, OH value of 170 mgKOH/g, a functionality of about 3.5; viscosity, ca. 3,400 mPa·s (25° C.);
CHP-H45, polymer polyol in the form of a milky-white viscous liquid, synthesized by free radical graft polymerization with initiator and monomers of styrene and acrylonitrile, from Changhua Chemical, hydroxyl value of 19-23 mgKOH/g, and functionality of 3, solid content at 41%-45%; viscosity, ca. 5,500~6,000 mPa·s (25° C.);
Diethylene glycol (“DEG”), a low molecular weight diol used as chain extender, with a functionality of 2, OH number: 1057 mgKOH/g, molecular weight, 106.124 g/mol; viscosity, 35.8 mPa·s (20° C.), from BASF;
Isocyanate: Polymeric methylene diphenyl diisocyanate (MDI), commercially available from BASF as LupranateR M20, with a functionality of approximately 2.7 and an NCO content of 31.5%; viscosity, ca. 210 mPa·s (25° C.);
Triethylene diamine, a tertiary amine catalyst commercially available as DABCOR 33-LV from Evonik;
1-methylimidazole from BASF;
Ethacure 100, diethyl toluenediamine available from Albemarle Corporation; and
T-Paste: a sodium aluminosilicate of the zeolite A type in oil from UOP, used as water scavenger.

### Synthesis of the Polyester Polyols

The raw materials of polyurethane systems in Examples (Ex. 1 and 2) and Comparative Examples (C.Ex. 1 through 6) were mixed by a VOLLRATH EWTKV 0.5 Lab stirrer and filled into a ball-shaped mold with a diameter of 300 mm by injection. The formulations of the polyurethane systems are given in Table 2.

The mold was mounted on a conventional rotational molding machine. The mold was rotated around two, perpendicular axes, axis 1 and axis 2. Axis 1 bisected the mold along one of its diameters. Axis 2 was perpendicular to axis 1. The rate of rotation about axis 1 was 15 RPM; the rate of rotation about axis 2 was 15 RPM. During the rotation, the temperature of the mold increased initially, and the peak temperature exceeded 60° C. The rotation stopped after the gel time of each example elapsed. After end of the rotation, the mold and its content were kept still to allow curing of the mixture and development of the strength of resultant material.

The temperature of the mold slowly decreased. The resultant material was shaped to a hollow ball. When the strength is sufficient, the mold was opened, and the hollow ball was removed. The duration from the end of the rotation to the removal of the ball is hereinafter termed “demolding time”.

The hollow ball was broken into pieces for measuring their thickness values. The minimum value and maximum value of thickness were recorded. A successful experiment of rotational molding generated a hollow ball with good mechanical strength and a narrow range of thickness distribution.

The process details and the testing data of the hollow balls (HB. 1 through 8) made from the polyurethane compositions in Examples and Comparative Examples are given in Table 3.

TABLE 2
Raw materials of polyurethane systems

| | | | | | | | |
|---|---|---|---|---|---|---|---|
| C. Ex. 1 | C. Ex. 2 | C. Ex. 3 | C. Ex. 4 | C. Ex. 5 | C. Ex. 6 | Ex. 1 | Ex. 2 |

Raw Materials
Polyol component (%)

| | | | | | | | | |
|---|---|---|---|---|---|---|---|---|
| Sovermol 805 | 0 | 0 | 0 | 0 | 0 | 0 | 0 | 31.8 |
| Castor oil | 51.5 | 46.5 | 51.5 | 32.5 | 31.7 | 31.8 | 31.5 | 0 |
| Lupranol 2095 | 10 | 10 | 10 | 10 | 10 | 10 | 10 | 10 |
| Lupranol VP9345 | 0 | 20 | 20 | 20 | 20 | 20 | 20 | 20 |
| DEG | 15 | 0 | 15 | 15 | 15 | 15 | 15 | 15 |
| CHP H45 | 20 | 20 | 0 | 20 | 20 | 20 | 20 | 20 |
| BYK-410 | 0 | 0 | 0 | 0 | 0 | 0 | 0 | 0.1 |
| BYK-431 | 0.2 | 0.2 | 0.2 | 0.2 | 0 | 0.2 | 0.2 | 0 |
| Triethylene diamine | 0 | 0 | 0 | 0 | 0 | 0 | 0 | 0.1 |
| 1-methylimidazole | 0.3 | 0.3 | 0.3 | 0.3 | 0.3 | 0 | 0.3 | 0 |
| Ethacure 100 | 1 | 1 | 1 | 0 | 1 | 1 | 1 | 1 |
| T-Paste | 2 | 2 | 2 | 2 | 2 | 2 | 2 | 2 |

Isocyanate component (%)

| | | | | | | | | |
|---|---|---|---|---|---|---|---|---|
| M20s | 100 | 100 | 100 | 100 | 100 | 100 | 100 | 100 |
| Isocyanate index (%) | 105 | 105 | 105 | 105 | 105 | 105 | 105 | 105 |

TABLE 3
Molding parameters and performances of hollow balls

| | | | | | | | | |
|---|---|---|---|---|---|---|---|---|
| | HB. 1 | HB. 2 | HB. 3 | HB. 4 | HB. 5 | HB. 6 | HB. 7 | HB. 8 |
| PU system | C. Ex. 1 | C. Ex. 2 | C. Ex. 3 | C. Ex. 4 | C. Ex. 5 | C. Ex. 6 | Ex. 1 | Ex. 2 |

Rotation

| | | | | | | | | |
|---|---|---|---|---|---|---|---|---|
| X axis speed | 15 | 15 | 15 | 15 | 15 | 15 | 15 | 15 |
| Y axis speed | 15 | 15 | 15 | 15 | 15 | 15 | 15 | 15 |
| Gel time (min) | 12 | 8 | 5 | 7 | 6 | 10 | 5 | 5 |
| Demolding (min) | 30 | 15 | 10 | 15 | 10 | 30 | 10 | 10 |
| Thickness range (mm) | 0.6-3.1 | 0.6-2.8 | 0.3-3.6 | 0.5-3.7 | 0.2-3.9 | 0.8-2.9 | 1.1-1.9 | 1.2-2.1 |
| Shore hardness | 62D | 70D | 73D | 74D | 75D | 73D | 75D | 75D |
| Remark | Soft | Brittle | Brittle | — | — | — | — | — |

Compared with any of Comparative Examples 2 through 6, Example 1, and Example 2, Comparative Example 1, which did not include a high functionality polyol in its formulation, generated a soft hollow sphere. Thus, it is indicated that the high functionality polyol brings hardness to the molded article.

Compared with any of Comparative Examples 4 through 6, Example 1, and Example 2, Comparative Example 2, which did not include a chain extender in its formulation, generated a brittle hollow sphere. Thus, it is indicated that chain extender brings toughness to the molded article.

Compared with any other Comparative Example, Example 1, or Example 2, Comparative Example 5 without any added rheological modifier, generated hollow sphere with the broadest range of thickness. Thus, it is indicated that rheological modifier renders the reacting mixture flowable while viscous, resulting in an evenly coated inner surface of the mold.

1. A two-component polyurethane system for rotational molding, comprising:
a polyol component comprising
a high functionality polyol with a functionality of larger than 3.5,
a bio-sourced polyol,
a viscosity modifier,
a chain extender in a content of from 10 wt. % to 20 wt. %, based on a total weight of the polyol component,
an amine catalyst,
a rheological modifier; and
a di- or polyisocyanate component.

2. The two-component polyurethane system according to claim 1, wherein the high functionality polyol is a polyether polyol initiated by an amine having at least three active hydrogen atoms boned with a nitrogen atom.

3. The two-component polyurethane system according to claim 1, wherein the high functionality polyol has a content of from 10 wt. % to 40 wt. %, based on the total weight of the polyol component.

4. The two-component polyurethane system according to claim 1, wherein the bio-sourced polyol comprises at least one selected from the group consisting of castor oil, hydrogenated castor oil, soybean oil polyol, palm oil polyol, rosin-based polyol, hydroxyl-modified fatty acid esters based on myristoleic acid, palmitoleic acid, oleic acid, vaccenic acid, petroselic acid, gadoleic acid, erucic acid, nervonic acid, linoleic acid, linolenic acid, stearidonic acid, arachidonic acid, timnodonic acid, clupanodonic acid and cervonic acid, and derivatives thereof.

5. The two-component polyurethane system according to claim 1, wherein the bio-sourced polyol has a functionality of 2.0 to 3.5.

6. The two-component polyurethane system according to claim 1, wherein the bio-sourced polyol has a content of from 20 to 50 wt. %, based on the total weight of the polyol component.

7. The two-component polyurethane system according to claim 1, wherein the viscosity modifier has a viscosity at 25° C. of more than 2,000 mPa·s, as measured in accordance with DIN EN 3219.

8. The two-component polyurethane system according to claim 1 further comprising a curing agent in a content of from 0.1 wt. % to 2.5 wt. %, based on the total weight of the polyol component.

9. The two-component polyurethane system according to claim 1, wherein an isocyanate index of the two-component polyurethane system is 80 to 120.

10. An article produced from the two-component polyurethane system according to claim 1.

11. The article according to claim 10, wherein the article is a hollow body.

12. The article according to claim 10, wherein the article is a mannequin.

13. A method for producing an article, comprising:
providing a two-component polyurethane system according to claim 1;
placing the two-component polyurethane system within a hollow mold;
subjecting the hollow mold to a rotational movement and causing the two-component polyurethane system to cure and form an article; and
retrieving the article.

14. The method according to claim 13, wherein the rotational movement has a duration of 3 to 30 minutes.

15. The method according to claim 13, wherein the rotational movement has a rotational speed of 10 to 60 round per minute.
